(19) United States
(12) Patent Application Publication
(10) Pub. No.: US 2026/0025567 A1
(43) Pub. Date: Jan. 22, 2026

(54) SUBJECT DETECTION APPARATUS AND SUBJECT DETECTION METHOD

(71) Applicant: CANON KABUSHIKI KAISHA, Tokyo (JP)

(72) Inventor: TATSUYA YAMAZAKI, Tokyo (JP)

(21) Appl. No.: 19/266,725

(22) Filed: Jul. 11, 2025

(30) Foreign Application Priority Data
Jul. 18, 2024 (JP) 2024-114939

(51) Int. Cl. H04N 23/611; H04N 23/60; H04N 23/67

(52) U.S. Cl. CPC H04N 23/611; H04N 23/64; H04N 23/67

(57) ABSTRACT

A subject detection apparatus includes a subject detection unit that detects a subject from an image obtained by capturing a sport handling a specific object, an object detection unit that detects the specific object from the captured image, and a setting unit that sets a main subject as a target of an autofocus operation from a plurality of subjects detected by the subject detection unit. In even in a case where a main subject candidate is newly detected, in a state in which the specific object is no longer detected from the captured image, the subject detection apparatus determines whether to switch a current main subject to the newly detected main subject candidate.

### BACKGROUND

### Field of the Technology

The present disclosure relates to a technical field for determining a main subject as a tracking target.

### Description of the Related Art

In moving image shooting, continuous shooting of still images, or the like, there is known a tracking function of determining a main subject from a plurality of moving subjects detected by an image capture apparatus and keeping focusing on the main subject. Especially when shooting a scene of a sport (a ball sport or the like) handling a specific object (a ball or the like), a plurality of subjects cross each other and a subject that is not targeted by a photographer may be determined as a main subject.

Japanese Patent Laid-Open No. 2020-145527 describes a method of estimating the posture of a player from an image of a sport using a moving object (ball), and controlling a camera work based on the movement of the player specified from the posture of the player and the speed and position of the moving object. Japanese Patent No. 7289080 describes a method of determining, based on a change in trajectory of a ball, whether a player takes an action on the ball, and recognizing the player who has taken the action.

However, Japanese Patent Laid-Open No. 2020-145527 and Japanese Patent No. 7289080 do not consider a status in which the specific object such as a ball is out of a shooting angle or a status in which the specific object is hidden by another subject to disappear.

A condition for determining a main subject when shooting a sport handling a specific object is that, for example, a subject is close to the specific object. However, if the main subject is determined under the condition that the specific object is detected, when the specific object disappears, the main subject cannot be determined, and a subject that is not targeted by a photographer may be focused on.

### SUMMARY

The present disclosure has been made in consideration of the aforementioned problems, and is directed to a subject detection apparatus comprising: a subject detection unit that detects a subject from an image obtained by capturing a sport handling a specific object; an object detection unit that detects the specific object from the captured image; and a setting unit that sets a main subject as a target of an autofocus operation from a plurality of subjects detected by the subject detection unit, wherein even in a case where a main subject candidate is newly detected, in a state in which the specific object is no longer detected from the captured image, the setting unit determines whether to switch a current main subject to the newly detected main subject candidate.

The present disclosure is directed to an image capture apparatus comprising: an imaging unit; a subject detection apparatus; and a focus control unit that executes an autofocus operation for a main subject, wherein the subject detection apparatus comprises: a subject detection unit that detects a subject from an image obtained by capturing a sport handling a specific object; an object detection unit that detects the specific object from the captured image; and a setting unit that sets a main subject as a target of an autofocus operation from a plurality of subjects detected by the subject detection unit, wherein even in a case where a main subject candidate is newly detected, in a state in which the specific object is no longer detected from the captured image, the setting unit determines whether to switch a current main subject to the newly detected main subject candidate.

The present disclosure is directed to a subject detection method comprising: detecting a subject from an image obtained by capturing a sport handling a specific object; detecting the specific object from the captured image; and setting a main subject as a target of an autofocus operation from a plurality of detected subjects, wherein even in a case where a main subject candidate is newly detected, in a state in which the specific object is no longer detected from the captured image, it is determined in the setting whether to switch a current main subject to the newly detected main subject candidate.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying the configuration of an image capture apparatus according to a present embodiment;

FIG. 2 is a block diagram exemplifying the configuration of a focus detection apparatus according to the present embodiment;

FIGS. 3A and 3B are flowcharts exemplifying main subject determination processing according to a first embodiment;

FIGS. 4A and 4B are views exemplifying posture information of subjects and object information according to the first embodiment;

FIG. 5 is a view exemplifying the structure of a neural network according to the first embodiment;

FIG. 6 is a flowchart exemplifying main subject setting processing corresponding to a ball disappearing status according to the first embodiment; and

FIG. 7 is a flowchart exemplifying main subject setting processing corresponding to a ball disappearing status according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An example in which a subject detection apparatus and an image capture apparatus according to the present disclosure are applied to a lens-integrated digital camera will be described below. However, the present disclosure is not limited to this, and may be applied to, for example, a film camera, an interchangeable lens digital camera, a digital video camera, a smartphone having a camera function, a tablet computer, a Web camera such as a monitoring camera, and the like.

The present embodiment will describe an example in which when the image capture apparatus includes a subject detection apparatus and shoots a scene of a (competitive) sport (a ball sport or the like) in which a plurality of subjects handle a specific object (a ball or the like), a subject (main subject) as the target (tracking target) of an autofocus operation (AF control) is determined. The sport can also be referred to as a game, a match, a contest, a competition or an event.

Note that the sport is a sport in which opposing competitor groups make one ball or a similar object reach a goal or an area in a set target space in a common space and compete for the higher score, and the sport includes field sports as well as water sports and ice sports. The sport includes physical sports (basketball, water polo, and the like) and stick sports (hockey, lacrosse, and the like). The field sports include basketball, handball, hockey, polo, lacrosse, and football (soccer, rugby, and American football). The water sports include water polo and the ice sports include ice hockey. Ice hockey or badminton is a sport handling, as a ball or a similar object, a non-spherical or non-ellipsoidal object unlike a ball.

### First Embodiment

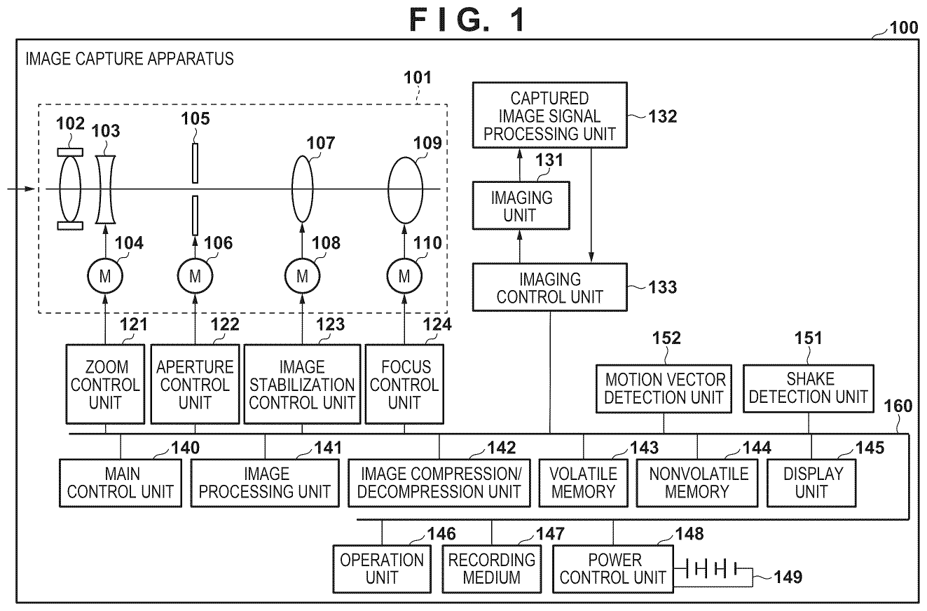

The first embodiment will be described with reference to FIGS. 1 to 6.

### <Apparatus Configuration>

The hardware configuration of the image capture apparatus according to the present embodiment will be described with reference to FIG. 1.

FIG. 1 is a block diagram exemplifying the hardware configuration of the image capture apparatus according to the present embodiment.

An image capture apparatus 100 according to the present embodiment includes a lens unit 101 controlled by a main control unit 140. The lens unit 101 forms a shooting optical system that causes an imaging unit 131 to form an optical image of a subject as reflected light from the subject under the control of the main control unit 140.

The lens unit 101 includes a fixed first lens group 102, a zoom lens 103 driven by a zoom lens driving unit 104, an aperture 105 driven by an aperture driving unit 106, a shift lens 107 driven by a shift lens driving unit 108, and a focus lens 109 driven by a focus lens driving unit 110.

The zoom lens 103 moves in an optical axis direction to change a focal length, thereby performing a zoom operation. The aperture 105 changes an aperture diameter to adjust the light amount of a subject image formed on the imaging plane of the imaging unit 131. The shift lens 107 moves in a direction perpendicular to the optical axis to change the optical axis, thereby performing an image stabilization. The focus lens 109 has a focus lens function of correcting the movement of the focal plane along with the zoom operation and a compensator lens function of adjusting the focus state.

A zoom control unit 121 drives the zoom lens 103 by controlling the motor of the zoom lens driving unit 104 under the control of the main control unit 140, thereby performing zoom control to change the focal length. An aperture control unit 122 drives the aperture 105 by controlling the motor of the aperture driving unit 106 under the control of the main control unit 140, thereby performing exposure control to adjust the aperture diameter of the aperture 105 and adjust the light amount in shooting. A focus control unit 124 drives the focus lens 109 by controlling the motor of the focus lens driving unit 110 under the control of the main control unit 140, thereby performing AF control to adjust the focus state of the subject.

An image stabilization control unit 123 drives the shift lens 107 by controlling the motor of the shift lens driving unit 108 in accordance with a shake of the image capture apparatus 100 under the control of the main control unit 140, thereby performing an image stabilization control to reduce a camera shake. The driving amount of the shift lens 107 is calculated, by the main control unit 140, as an image stabilization amount for canceling the shake of the image capture apparatus 100 detected by a shake detection unit 151. Detection of the shake of the image capture apparatus 100 by the shake detection unit 151 and the image stabilization by the shift lens 107 require movements in two axis directions of a yaw direction and a pitch direction but FIG. 1 shows only one axis in a simplified manner. The detection result of the shake detection unit 151 is used not only for calculation of the image stabilization amount of the image capture apparatus 100 but also for determination of panning of the image capture apparatus 100 in the horizontal direction and tilting of the image capture apparatus 100 in the vertical direction by a photographer.

Each lens of the lens unit 101 is normally formed from a plurality of lenses, but is represented by one lens in FIG. 1 in a simplified manner.

A subject image formed on the imaging plane of the imaging unit 131 by the lens unit 101 is converted into an electrical signal by the imaging unit 131. The imaging unit 131 is an image sensor including a photoelectric conversion element such as a CCD or CMOS sensor that photoelectrically converts the subject image (optical image) into an electrical signal. In the imaging unit 131, photoelectric conversion elements of m pixels in the horizontal direction and n pixels in the vertical direction are arranged. An image signal generated by the imaging unit 131 undergoes predetermined signal processing by a captured image signal processing unit 132, and is output as image data. This can obtain an image on the imaging plane. For example, in a case of a setting of NTSC and FHD/60p, image data corresponding to 1,920 pixels×1,080 pixels is obtained for each frame (1/60 sec).

The image data processed by the captured image signal processing unit 132 is output to an imaging control unit 133, and temporarily stored in a volatile memory. The image data stored in the volatile memory undergoes various kinds of image processes by an image processing unit 141, undergoes compression processing by a compression/decompression unit 142, and is then recorded in a recording medium 147 such as a memory card.

The compression/decompression unit 142 compression encodes the image data output from the image processing unit 141 by a moving image or still image compression method to record the thus obtained data as an image file in the recording medium 147, and decodes an image file read out from the recording medium 147. The recording medium 147 is a hard disk drive (HDD), a solid-state drive (SSD), a memory card, or the like. The recording medium 147 may be configured to be detachable from the image capture apparatus 100 or not to be readily detachable from the image capture apparatus 100.

The image processing unit 141 applies predetermined image processing to the image data stored in the volatile memory. The predetermined image processing includes white balance processing, color interpolation (demosaicing) processing, development processing such as gamma correction processing, a signal format conversion processing, and scaling processing but the present disclosure is not limited to these.

The image processing unit 141 executes subject detection processing for the image data to detect subjects in the image. The image processing unit 141 determines a main subject based on the posture information (for example, joint positions) of the detected subjects, the position information of an object (to be referred to as a specific object hereinafter) specific to a shooting scene, and the like. Note that in the present embodiment, the subjects are persons, and the main subject is a subject as a shooting target (AF control target) of the photographer. For example, in a case where the main subject plays a ball sport, it can be expected to improve the determination accuracy of the main subject by handling a detected ball as the specific object.

The image processing unit 141 may use the determination result of the main subject for image processing (for example, white balance processing). The image processing unit 141 stores, in the volatile memory, the image data having undergone the image processing, the posture information of the detected subjects, the position and size information of the specific object, the center of gravity of the main subject, face and eye position information, and the like.

A display unit 145 displays an image (live view) being captured or a shot still image, a moving image being recorded, detected subjects and a main subject in a displayed image, a GUI for an interactive operation, and the like. The display unit 145 is a display device such as a liquid crystal display or an organic EL display. The display unit 145 may be integrated with the image capture apparatus 100 or may be an external apparatus connected to the image capture apparatus 100.

An operation unit 146 is an operation member including switches, buttons, a ring, and a lever for accepting a user operation, and outputs, to the main control unit 140, an operation signal corresponding to the operation member operated by the user. The main control unit 140 performs control by outputting a control signal to each component of the image capture apparatus 100 including the lens unit 101 based on the operation signal. The operation member includes, for example, a touch panel integrated with the display unit 145. The photographer as the user can perform various operations on the image capture apparatus 100 by operating the operation unit 146. The photographer can make various settings in the image capture apparatus 100 by operating, using the operation unit 146, a Graphical User Interface (GUI) displayed on the display unit 145.

The operation unit 146 includes at least a still image shooting button, a moving image shooting button, a mode dial, and a power switch. The still image shooting button is an operation member for instructing the main control unit 140 to perform still image shooting processing. The moving image shooting button is an operation member for instructing the main control unit 140 to perform moving image shooting processing. The mode dial is an operation member for switching the operation mode of the image capture apparatus 100. The mode dial can be used to switch the operation mode of the image capture apparatus 100 to any of a still image shooting mode, a moving image shooting mode, and a reproduction mode. The power switch is an operation member for switching power-on/off of the image capture apparatus 100.

A power control unit 148 controls supply of electric power from a battery 149 to each component of the image capture apparatus 100 in accordance with the state of the image capture apparatus 100 under the control of the main control unit 140. The battery 149 is a secondary battery that can supply electric power to operate the image capture apparatus 100.

When the still image shooting button is pressed halfway in the still image shooting mode, the main control unit 140 starts auto exposure (AE) control and AF control. When the still image shooting button is pressed fully, the main control unit 140 executes still image shooting processing of recording the image data captured by the imaging unit 131 in the recording medium 147.

The main control unit 140 performs AE control and AF control for the image data (frame) captured by the imaging unit 131 when the moving image shooting button is pressed for the first time in the moving image shooting mode, continues moving image shooting processing of recording a moving image of a predetermined time in the recording medium 147, and stops the moving image shooting processing when the moving image shooting button is pressed again.

A volatile memory 143 is, for example, a DRAM, and is used as a buffer memory that temporarily holds image data captured by the imaging unit 131, an image display memory for the display unit 145, a working area of the main control unit 140, or the like.

A nonvolatile memory 144 is, for example, a flash ROM, and stores a control program executed by the main control unit 140, and the like. When the power is turned on by a user operation and the image capture apparatus 100 is activated, the control program stored in the nonvolatile memory 144 is read out (loaded) into a part of the volatile memory 143. The main control unit 140 controls the operation of the image capture apparatus 100 in accordance with the control program loaded into the volatile memory 143.

The main control unit 140 performs arithmetic processing for controlling the image capture apparatus 100 including the lens unit 101. The main control unit 140 includes at least one programmable processor such as a CPU that controls the components of the image capture apparatus 100. The main control unit 140 controls the respective components of the image capture apparatus 100 by loading the program stored in the nonvolatile memory 144 into the volatile memory 143 and executing the program, thereby implementing the function of the image capture apparatus 100. Note that instead of controlling the overall image capture apparatus 100 by the main control unit 140, the overall image capture apparatus 100 may be controlled by causing a plurality of hardware components to share the processing.

The main control unit 140 executes AF processing of controlling the focus control unit 124 to drive the focus lens 109 based on a focus detection result by a phase difference detection method or a TV-AF method.

In addition, the main control unit 140 executes auto exposure (AE) processing of automatically determining an exposure condition (shutter speed or accumulation time, f-number, and sensitivity) based on luminance information of a subject. For example, the luminance information of the subject can be obtained by the image processing unit 141. The main control unit 140 can determine the exposure condition with reference to a specific subject region such as the face of a person.

The shake detection unit 151 detects a shake of the image capture apparatus 100. The shake detection unit 151 detects shake amounts of the image capture apparatus 100 in three axis directions orthogonal to each other. The shake detection unit 151 is, for example, a gyro sensor that detects angular velocities in the three axis directions including a pitch direction, a yaw direction, and a roll direction in the image capture apparatus 100.

In the image capture apparatus 100 according to the present embodiment, the image stabilization control unit 123 controls the shift lens driving unit 108 to drive the shift lens 107 under the control of the main control unit 140, thereby performing an optical image stabilization. Note that the imaging control unit 133 may perform the optical image stabilization by moving the imaging unit 131 based on the shake amounts of the image capture apparatus 100 detected by the shake detection unit 151, or the image processing unit 141 may perform, under the control of the main control unit 140, electronic shake correction of the image based on the shake amounts of the image capture apparatus 100 detected by the shake detection unit 151.

A motion vector detection unit 152 detects an inter-frame motion vector for each frame. For example, the position, in the shooting angle, of the main subject detected in a given frame and a next frame shifts, a moving amount in the shooting angle of the main subject in each of the horizontal X direction and the vertical Y direction can be obtained in, for example, a 1/256 pixel basis. The detection target of the motion vector detection unit 152 is not only the main subject, and a plurality of motions of the specific object, the whole background, and the like can be detected simultaneously.

Motion vector information as the detection result of the motion vector detection unit 152 can be used for the purpose of further correcting the remaining blur after the image stabilization by the shift lens 107 by using, for example, the motion information of the whole background. The motion vector information can also be used for special image processing of fixing the main subject at a certain position in the shooting angle, alignment when combining a plurality of frames, and the like.

Furthermore, by using the detection result of the shake detection unit 151 and the main subject detection result of the motion vector detection unit 152, it is possible to determine, with high probability, whether the photographer is tracking the subject or wants to switch to another subject.

The respective components of the image capture apparatus 100 are connected to be able to exchange data via a bus 160, and controlled by the main control unit 140.

### <Main Subject Determination Processing>

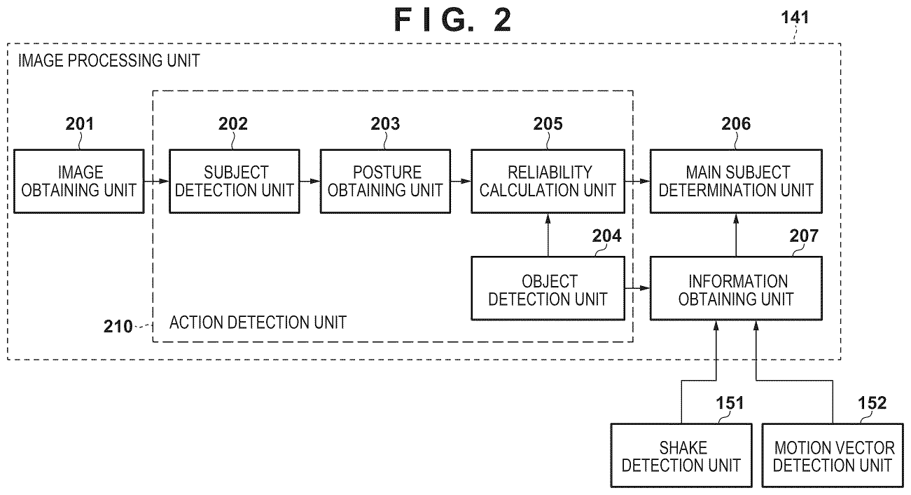

Main subject determination processing according to the present embodiment will be described next with reference to FIGS. 2 to 6.

FIG. 2 is a block diagram exemplifying the configuration of the image processing unit 141 serving as a subject detection apparatus according to the present embodiment, and exemplifies function blocks from when the image processing unit 141 obtains image data until a main subject is determined.

Each function of the image processing unit 141 is implemented by hardware and/or software. Note that in a case where each function block shown in FIG. 2 is formed by hardware instead of being implemented by software, a circuit configuration corresponding to each function block shown in FIG. 2 is provided.

An image obtaining unit 201 obtains image data captured at a time of interest from the imaging control unit 133. A subject detection unit 202 detects (one or more) persons as subjects in the image obtained by the image obtaining unit 201. A posture obtaining unit 203 performs posture estimation for each of the plurality of subjects detected by the subject detection unit 202, thereby obtaining posture information. The contents of the posture information to be obtained are determined in accordance with the type of the subject. In the present embodiment, since the subject is a person, the posture obtaining unit 203 obtains the pieces of position information of a plurality of joints of the person.

An object detection unit 204 detects a specific object from the image obtained by the image obtaining unit 201, and obtains the two-dimensional coordinates and the size of the specific object in the image. The type of the specific object to be detected is determined based on a shooting scene. In the present embodiment, since the shooting scene is a ball sport, the object detection unit 204 detects a ball used as the specific object in the sport.

Note that the posture estimation method and the object detection method are not limited to specific methods. For example, methods described in literatures 1 and 2 below can be used.

### (Literature 1)

Redmon, Joseph, et al., “You only look once: Unified, real-time object detection.”, Proceedings of the IEEE conference on computer vision and pattern recognition, 2016.

### (Literature 2)

Cao, Zhe, et al., “Realtime multi-person 2d pose estimation using part affinity fields.”, Proceedings of the IEEE Conference on Computer Vision and Pattern Recognition, 2017.

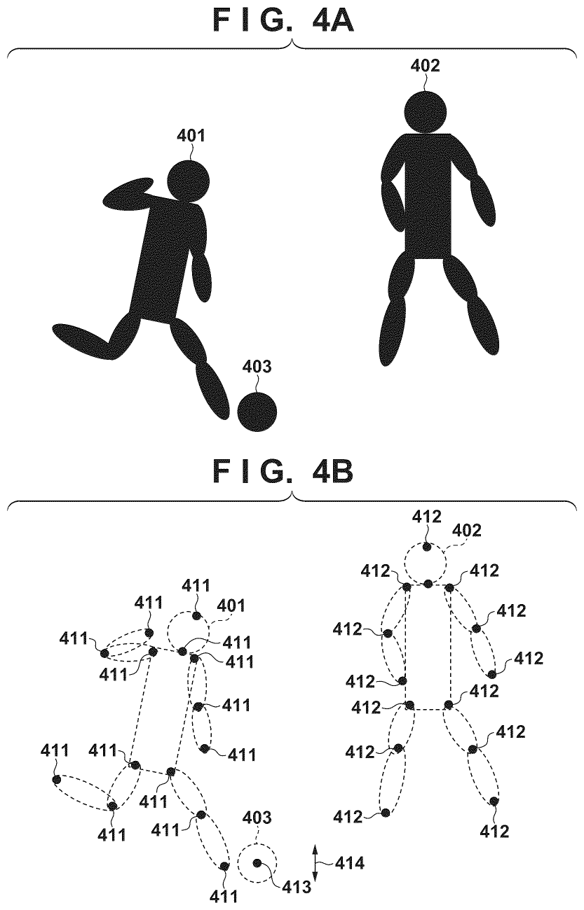

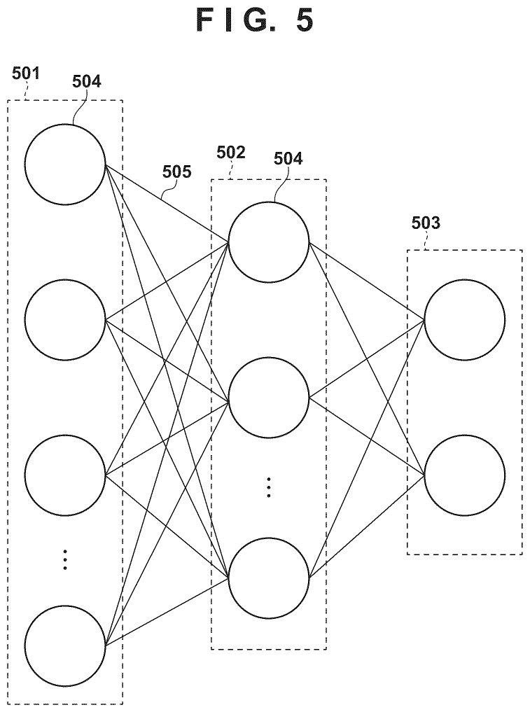

FIGS. 4A and 4B are views exemplifying the posture information of the subjects and the object information according to the present embodiment.

FIG. 4A exemplifies a target image of the main subject determination processing according to the present embodiment. In the example shown in FIG. 4A, a subject 401 is about to kick a ball 403. The subject 401 is a subject that takes a specific important action in a shooting scene. In the present embodiment, by using the posture information of the subjects and the object information of the specific object (ball), the main subject that is highly probably intended as an image capturing target (tracking target) by the photographer is determined. On the other hand, a subject 402 is a non-main subject. The non-main subject is a subject other than the main subject.

FIG. 4B exemplifies the posture information of the subjects 401 and 402 and the object information including the position and the size of the ball 403 in FIG. 4A. Joints 411 represent the joints of the subject 401, and joints 412 represent the joints of the subject 402. In the example shown in FIG. 4B, pieces of position information of the head top, neck, shoulders, elbows, wrists, waist, knees, and ankles as joints are obtained. However, the joint positions are not limited to these, and may be some of them, or other position information may be obtained. In addition to the joint positions, information of axes each connecting the joints and the like may be used, and arbitrary information can be used as the posture information as long as the information represents the posture of the subject. A case where the joint positions are obtained as the posture information will be described below.

The posture obtaining unit 203 obtains two-dimensional coordinates (x, y) of each of the joints 411 and 412 in the image. The unit of the coordinates (x, y) is pixels. A position 413 of the center of gravity represents the position of the center of gravity of the ball 403, and an arrow 414 represents the size of the ball 403 in the image. The object detection unit 204 obtains the two-dimensional coordinates (x, y) of the position of the center of gravity of the ball 403 in the image and the number of pixels indicating the width of the ball 403 in the image.

A reliability calculation unit 205 calculates reliability (probability value) representing the likelihood of the main subject for each subject based on at least one of the coordinates of the joint positions estimated by the posture obtaining unit 203 and the coordinates and size of the specific object obtained by the object detection unit 204. A case where a neural network as one method of machine learning is used as an example of a method of calculating reliability will be described.

FIG. 5 is a view exemplifying the structure of a neural network.

The neural network includes an input layer 501, an intermediate layer 502, an output layer 503, neurons 504, and lines 505 each indicating the connection relationship between the neurons 504. FIG. 5 shows a simplified view by denoting only representative neurons and connection lines by reference numerals. Assume that the number of neurons 504 of the input layer 501 is equal to the number of dimensions of input data, and the number of neurons of the output layer 503 is two. This corresponds to the binary classification problem for determining whether a subject is the main subject.

A line 505 that connects the ith neuron 504 of the input layer 501 and the jth neuron 504 of the intermediate layer 502 is given a weight wⱼᵢ, and a value zⱼ output from the jth neuron 504 in the intermediate layer 502 is given by:

$${z}_{j} = h ( {b}_{j} + {\sum }_{i} {w}_{ji} {x}_{i} ) \qquad ( 1 )$$

$$h ( z ) = max ( z , 0 ) \qquad ( 2 )$$

In equation (1), xᵢ represents a value input to the ith neuron 504 of the input layer 501. The sum is obtained for all the neurons 504 of the input layer 501, which are connected to the jth neuron. bⱼ is called a bias, and represents a parameter for controlling the ease of firing of the jth neuron 504. The function h defined by equation (2) is an activation function called a Rectified Linear Unit (ReLU). As the activation function, another function such as a sigmoid function can be used. A value yₖ output from the kth neuron 504 of the output layer 503 is given by:

$${y}_{k} = f ( {b}_{k} + {\sum }_{j} {w}_{kj} {z}_{j} ) \qquad ( 3 )$$

$$f ( {y}_{k} ) = \frac{exp ( {y}_{k} )}{{\sum }_{i} exp ( {y}_{i} )} \qquad ( 4 )$$

In equation (3), zⱼ represents a value output from the jth neuron 504 of the intermediate layer 502, and i, k=0, 1 where 0 corresponds to the non-main subject and 1 corresponds to the main subject. The sum is obtained for all the neurons of the intermediate layer 502, which are connected to the kth neuron. The function f defined by equation (4) is called a softmax function, and outputs a probability value of belonging to the kth class. In the present embodiment, f(y₁) is used as the probability representing the likelihood of the main subject.

When performing learning processing, the coordinates of the joint positions of the subject and the coordinates and size of the specific object are input. Then, all weights and biases are optimized so as to minimize a loss function using the output probability and a correct answer label. The correct answer label takes two values of “1” for the main subject and “0” for the non-main subject. As a loss function L, it is possible to use binary cross entropy given by:

$$L ( y , t ) = - {\sum }_{m} {t}_{m} log {y}_{m} - {\sum }_{m} ( 1 - {t}_{m} ) log ( 1 - {y}_{m} ) \qquad ( 5 )$$

In equation (5), the suffix m represents the index of the subject as the target of the learning processing. yₘ represents a probability value output from the neuron 504 of k=1 in the output layer 503, and tₘ represents the correct answer label. Other than equation (5), the loss function is any function capable of measuring the degree of matching to the correct answer label, such as mean square error. By performing optimization based on equation (5), it is possible to determine the weight and bias so that the output probability value becomes close to the correct answer label.

The learned weight and bias value are stored in advance in the nonvolatile memory 144, and read out into the volatile memory 143, as needed. A plurality of kinds of weights and bias values may be prepared in accordance with a shooting scene. The reliability calculation unit 205 outputs the probability value f(y₁) based on equations (1) to (4) using the learned weight and bias (the result of machine learning performed in advance).

Note that when performing learning processing, the state of the main subject before shifting to a specific important action can be learned. For example, in a case where the subject kicks the ball, a state in which the subject raises his/her leg to kick the ball can be learned as one state of the main subject. This is because the image capture apparatus 100 is required to accurately execute control when the main subject actually takes a specific important action. For example, by starting control (recording control) to automatically record a moving image or a still image when the reliability (probability value) corresponding to the main subject exceeds a preset threshold, the photographer can shoot an important moment without missing it. In this case, typical time information from the state as the target of the learning processing to the specific important action may be used to control the image capture apparatus 100.

Note that the learning processing of the present embodiment may be executed by dedicated hardware such as a Graphics Processing Unit (GPU), may be executed in accordance with a program operated by the CPU of the main control unit 140, or may be executed using them in combination.

The present embodiment has explained the method of calculating the reliability (probability value) using the neural network. However, other machine learning methods such as support vector machine and a decision tree may be used as long as it is possible to perform classification of whether a subject is the main subject. The present disclosure is not limited to machine learning, and a function of outputting reliability (probability value) based on a given model may be constructed.

The present embodiment has explained a case where the probability that the subject is the main subject of the processing target image is adopted as reliability representing the likelihood of the main subject (reliability corresponding to the degree of probability that the subject is the main subject of the processing target image), but a value other than the probability may be used. For example, the reciprocal of the distance between the position of the center of gravity of the subject and the position of the center of gravity of the specific object can be used as reliability.

An action detection unit 210 includes the subject detection unit 202, the posture obtaining unit 203, the object detection unit 204, and the reliability calculation unit 205. The action detection unit 210 detects the subject with the highest reliability (probability value) from the plurality of subjects detected by the subject detection unit 202, and outputs a detection result indicating that the subject taking an action is detected from the obtained image.

A main subject determination unit 206 determines the main subject based on the detection result of the action detection unit 210 and a detection result of an information obtaining unit 207.

The information obtaining unit 207 outputs the detection result of the shake detection unit 151, the detection result of the motion vector detection unit 152, and the detection result of the object detection unit 204 to the main subject determination unit 206.

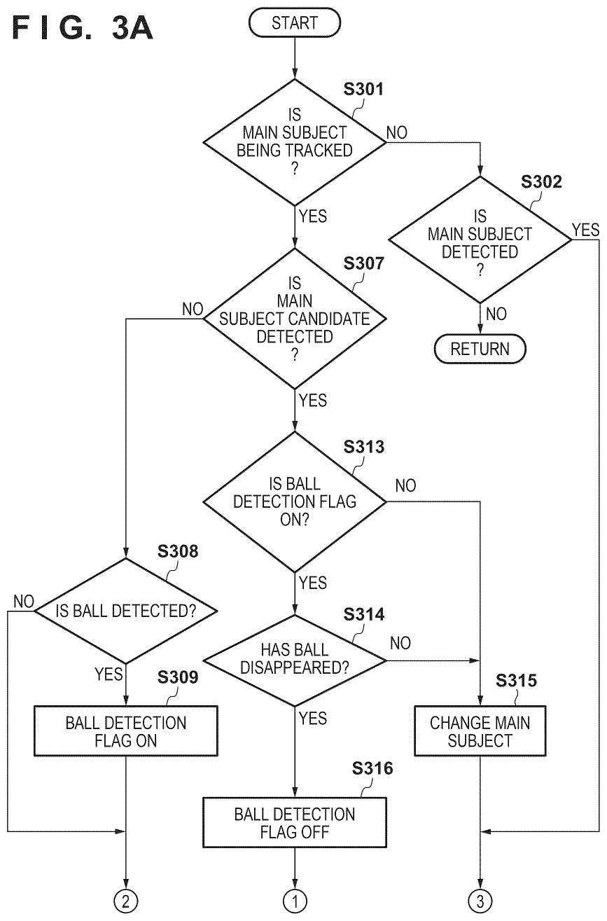

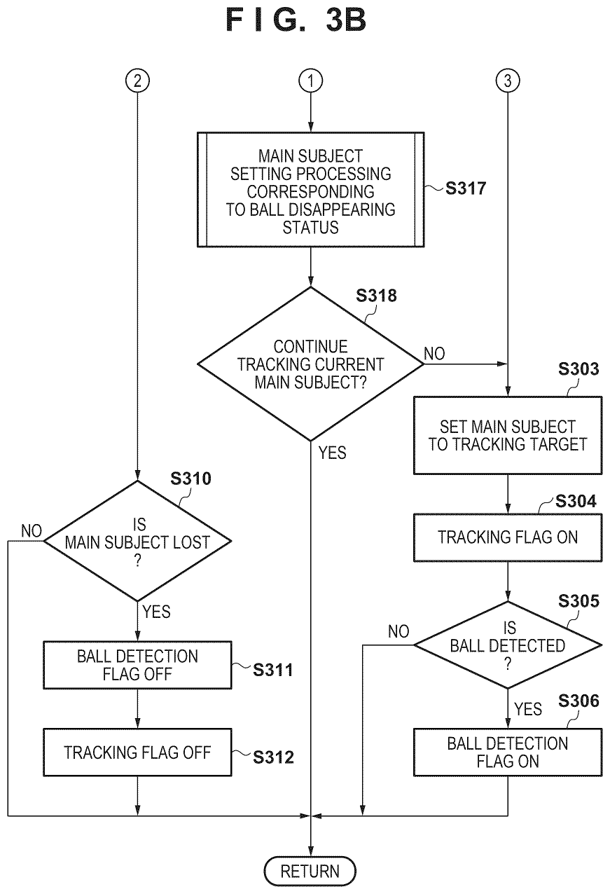

The main subject determination processing by the main subject determination unit 206 according to the present embodiment will be described next with reference to FIGS. 3A and 3B.

FIGS. 3A and 3B are flowcharts exemplifying the processing of the main subject determination unit 206 shown in FIG. 2.

The processing shown in FIGS. 3A and 3B is implemented when the image processing unit 141 of the present embodiment functions as the main subject determination unit 206 under the control of the main control unit 140. Note that the processing shown in FIGS. 3A and 3B is executed while the photographer is shooting a ball sport (for example, basketball) in a case where the tracking function of keeping focusing on the main subject in the still image shooting mode or the moving image shooting mode is enabled. Note that the type of the sport is not limited to basketball.

In step S301, the main subject determination unit 206 determines whether the main subject taking an action is being tracked. Before the main subject is detected for the first time, no tracking state is set, and thus the processing advances to step S302.

In step S302, the main subject determination unit 206 determines whether the action detection unit 210 detects the main subject taking an action. When no main subject taking an action is detected, the processing ends. When the main subject taking an action is detected, the processing advances to step S303.

In steps S303 and S304, the main subject determination unit 206 sets, as a tracking target, the main subject taking an action, and turns on a tracking flag. The setting of the tracking target is to store, as a template, the color information and luminance information of the currently selected main subject. Thus, even if the tracking target cannot be detected, it is possible to continue tracking the subject as the tracking target based on the template.

In step S305, based on the detection result of the object detection unit 204 obtained by the information obtaining unit 207, the main subject determination unit 206 determines whether a ball is detected. When no ball is detected, the processing ends. When the ball is detected, the processing advances to step S306.

In step S306, the main subject determination unit 206 turns on a ball detection flag.

When the main subject taking an action is detected by the action detection unit 210, and is set as a tracking target, the processing advances from step S301 to step S307.

In step S307, the main subject determination unit 206 determines whether the action detection unit 210 detects a new main subject candidate. A condition for detecting a new main subject candidate is that, for example, among the plurality of subjects detected by the subject detection unit 202, the reliability of the current main subject decreases and the reliability of another subject increases. When the action detection unit 210 detects a new main subject candidate, the processing advances to step S313. When no new main subject candidate is detected, the processing advances to step S308.

In step S308, the main subject determination unit 206 determines whether the ball is currently detected, similar to step S305. When no ball is detected, the processing skips processing of step S309 and advances to step S310. When the ball is detected, the processing advances to step S309.

In step S309, the main subject determination unit 206 turns on the ball detection flag.

In step S310, the main subject determination unit 206 determines whether the main subject is lost. The state in which the subject is lost is a state in which the detection result of the main subject cannot be obtained and the target matching the template set in step S303 disappears, and means that the main subject is out of the shooting angle. When it is determined in step S310 that the subject is lost, the processing advances to step S311. When the subject is not lost, the processing skips processing of steps S311 and S312 and continues tracking the current main subject.

In steps S311 and S312, the main subject determination unit 206 turns off the ball detection flag and the tracking flag.

When a new subject is detected in step S307, the processing advances to step S313, and the main subject determination unit 206 determines whether the ball detection flag is ON. When the ball detection flag is ON, the processing advances to step S314. When the ball detection flag is OFF, the processing advances to step S315.

In step S314, the main subject determination unit 206 determines whether the ball has disappeared. Information indicating whether the ball has disappeared is obtained from the information obtaining unit 207. When the ball has disappeared, the processing advances to step S316. When the ball has not disappeared, the processing advances to step S315.

When the processing advances from step S313 to step S315, this means that the reliability of the current main subject and the reliability of the newly detected main subject candidate are reversed in the state in which no ball is detected. When the processing advances from step S314 to step S315, this means that the reliability of the current main subject and the reliability of the newly detected main subject candidate are reversed in the state in which the ball is detected. In either case, the main subject taking an action has changed, and thus the current main subject is switched to the newly detected main subject candidate in step S315. When the main subject is switched in step S315, the tracking target changes, and thus the processing in steps S303 to S306 are re-executed, thereby ending the processing.

When a main subject candidate is newly detected in step S307, this means that the reliability of the newly detected main subject candidate is higher than the reliability of the current main subject. Therefore, the current main subject should originally be switched to the newly detected main subject candidate. However, in the present embodiment, when detecting the subject taking a specific action, the detection state of the ball by the object detection unit 204 also contributes to the reliability of the main subject. That is, when the ball disappears from the shooting angle, the reliability of the current main subject may abruptly decrease. In this case, the reliability of the current main subject and the reliability of the newly detected main subject candidate are highly probably reversed, and the main subject may be switched to the newly detected main subject candidate different from the main subject as the tracking target of the photographer. In view of this, in the present embodiment, even if a main subject candidate is newly detected in step S307, when the ball detected until just before disappears in step S314, the processing advances to step S316 without immediately switching the main subject, and it is determined whether to switch the current main subject to the newly detected main subject candidate.

In step S316, the main subject determination unit 206 turns off the ball detection flag.

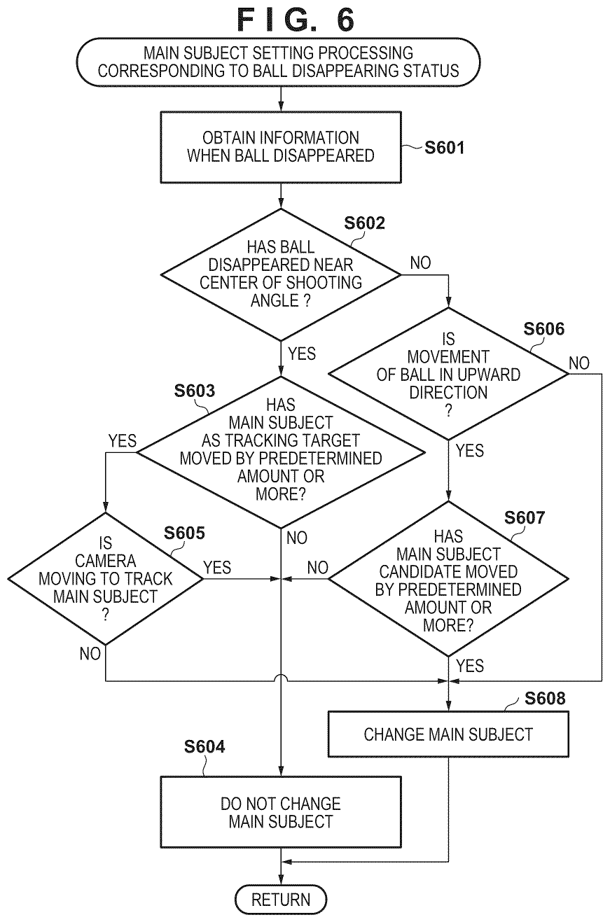

In step S317, the main subject determination unit 206 performs main subject setting processing corresponding to a ball disappearing status. Details of this processing will be described later with reference to FIG. 6.

In step S318, the main subject determination unit 206 shifts to processing of performing a necessary operation based on a main subject setting result in step S317. That is, when the current main subject is continuously tracked, the processing ends. When the main subject is to be changed, the processing advances to step S303 and the main subject as the tracking target is set.

FIG. 6 is a flowchart exemplifying the main subject setting processing in step S317 of FIG. 3B.

In step S601, the main subject determination unit 206 obtains various kinds of information in accordance with the ball disappearing status. These are pieces of information obtained from the information obtaining unit 207, and include ball detection information, the detection result of the shake detection unit 151, the detection result of the motion vector detection unit 152, and pieces of time-series information thereof.

In step S602, the main subject determination unit 206 determines, based on the position of the ball according to the ball disappearing status, whether the ball has disappeared near the center of the shooting angle. When the ball has disappeared near the center of the shooting angle, the processing advances to step S603. When the ball has disappeared at a position not near the center of the shooting angle, the processing advances to step S607.

In step S603, the main subject determination unit 206 determines whether the main subject as the tracking target has moved by a predetermined amount or more. Whether the main subject as the tracking target has moved by the predetermined amount or more can be determined based on the moving amount of the main subject as the tracking target within the shooting angle using the detection result of the motion vector detection unit 152. When the main subject as the tracking target has not moved by the predetermined amount or more and thus the movement is small, the processing advances to step S604. When the main subject as the tracking target has moved by the predetermined amount or more and thus the movement is large, the processing advances to step S605.

In step S605, the main subject determination unit 206 determines whether the photographer shakes the image capture apparatus 100 to track the main subject. This can be determined based on whether the detection result of the shake detection unit 151 matches the direction in which the main subject has moved within the shooting angle. When the photographer is tracking the main subject, the processing advances to step S604. When the photographer is not tracking the main subject, the processing advances to step S608.

When the ball has disappeared near the center of the shooting angle, a state in which the ball is behind another player or an obstacle can be assumed. For example, there are a case where the ball disappears by crossing another player during dribbling in basketball, and a case where the ball is hidden by the goal at the time of a lay-up shot or a dunk shot. When the processing advances from step S603 to step S604, the movement of the main subject is small and the photographer is tracking the main subject, which is considered to correspond to the above-described scene. Therefore, in step S604, a selection is made not to change the main subject. On the other hand, when the processing advances from step S602 to step S606, for example, a scene in which the player himself/herself feints and passes the ball (from behind the player himself/herself) and then runs to another place can be considered. In this case, it is considered that the photographer tracks the ball, but the place where a player as the next main subject candidate who receives the ball stays is generally in the opposite direction of the moving direction of the main subject as the tracking target, and thus the image capture apparatus 100 moves in the opposite direction of the moving direction of the main subject. That is, since the main subject is to be changed, the main subject is changed in step S608.

When it is determined in step S602 that the disappearance position of the ball is not near the center of the shooting angle, the ball has disappeared near the boundary of the shooting angle, and it is determined in step S606 whether the disappearance position of the ball is on the upper side of the shooting angle. Which direction the ball moves in can be determined by confirming the motion vector of the object. When it is determined in step S606 that the disappearance position of the ball is on the upper side of the shooting angle, the processing advances to step S607. When the disappearance position of the ball is not on the upper side, the processing advances to step S608. Note that when the type of the sport is not basketball, the disappearance position of the ball is not limited to the upper side of the shooting angle, and a condition corresponding to the type of the sport such as the front side, the rear side or the lower side is set.

In step S607, the main subject determination unit 206 determines whether the newly detected main subject candidate has moved by the predetermined amount or more. When the newly detected main subject candidate has moved by the predetermined amount or more and thus the movement is large, the processing advances to step S608. When the newly detected main subject candidate has not moved by the predetermined amount or more and thus the movement is small, the processing advances to step S604. When the disappearance position of the ball is not on the upper side of the shooting angle, the ball is highly probably passed to another player, and thus the main subject is highly probably to be changed. Therefore, the main subject is changed in step S608. When it is determined in step S607 that the movement of the newly detected main subject candidate is small, for example, a free throw is considered, and thus it is determined, in step S604, not to change the main subject.

The action detection unit 210 notifies the main subject determination unit 206 of the subject with the highest reliability (probability value) as the main subject candidate among the subjects (persons) detected by the subject detection unit 202. Then, the main subject determination unit 206 selects the main subject based on the ball detection information of the information obtaining unit 207 and the like, and stores the coordinates of the joint positions of the main subject and the representative coordinates (the position of the center of gravity, the position of the face, or the like) representing the main subject in the volatile memory 143. This completes the main subject determination processing.

### Second Embodiment

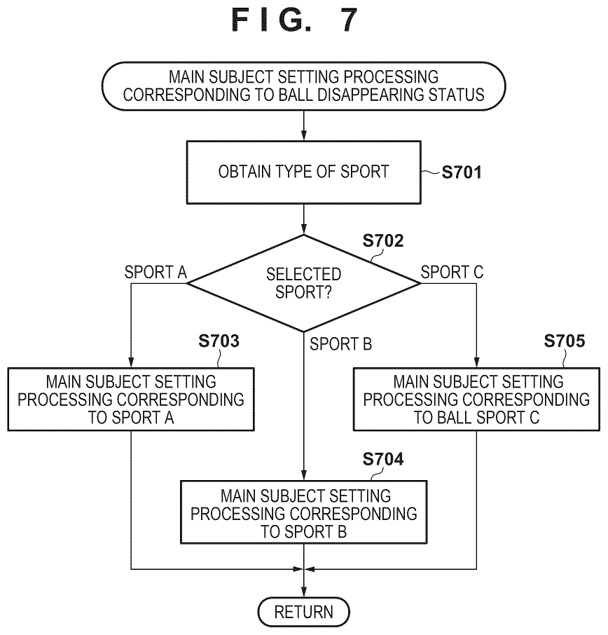

The second embodiment will be described next with reference to FIG. 7.

In the second embodiment, the photographer can select a type of a sport to be shot by operating an operation unit 146, and main subject setting processing corresponding to the sport selected by the photographer is performed.

The configurations of an image capture apparatus 100 and an image processing unit 141 serving as a subject detection apparatus according to the second embodiment are the same as those shown in FIGS. 1 and 2 of the first embodiment, and main subject setting processing corresponding to a ball disappearing status in step S317 of FIG. 3B as the operation of a main subject determination unit 206 is different.

FIG. 7 is a flowchart exemplifying main subject setting processing corresponding to a ball disappearing status in step S317 of FIG. 3B according to the second embodiment.

Referring to FIG. 7, in step S701, the main subject determination unit 206 obtains a type of a sport selected by the photographer operating the operation unit 146.

In step S702, the main subject determination unit 206 advances to processing corresponding to the sport selected by the photographer in step S701. When sport A is set in step S702, the processing advances to step S703. When sport B is set in step S702, the processing advances to step S704. When sport C is set in step S702, the processing advances to step S705.

In each of steps S703, S704, and S705, the main subject determination unit 206 performs main subject setting processing optimum for each sport.

In the second embodiment, when the photographer selects a sport to be shot, and main subject setting processing optimum for the selected sport is performed, the possibility that a main subject intended as an image capturing target (tracking target) by the photographer is unwantedly switched at the time of disappearance of a ball in each sport can largely be reduced.

According to each of the above-described embodiments, even if the action detection unit 210 detects a new main subject candidate, it is determined whether to switch the main subject, in accordance with whether a ball has disappeared and the disappearing status of the ball. This can avoid a situation in which the main subject intended as an image capturing target (tracking target) by the photographer who is shooting the sport is unnecessarily switched.

According to the present disclosure, when shooting a sport handling a specific object, even if the specific object disappears, it is possible to keep focusing on a subject targeted by a photographer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-114939, filed Jul. 18, 2024 which is hereby incorporated by reference herein in its entirety.

What is claimed is:

1. A subject detection apparatus comprising:
a subject detection unit that detects a subject from an image obtained by capturing a sport handling a specific object;
an object detection unit that detects the specific object from the captured image; and
a setting unit that sets a main subject as a target of an autofocus operation from a plurality of subjects detected by the subject detection unit,
wherein even in a case where a main subject candidate is newly detected, in a state in which the specific object is no longer detected from the captured image, the setting unit determines whether to switch a current main subject to the newly detected main subject candidate.

2. The apparatus according to claim 1, wherein
even in a case where the main subject candidate is newly detected, in a state in which the specific object is no longer detected from the captured image, the setting unit determines, in accordance with a status in which the specific object is not detected, whether to switch the current main subject to the newly detected main subject candidate.

3. The apparatus according to claim 2, wherein
even in a case where the main subject candidate is newly detected while the specific object is detected from the captured image, in a state in which the specific object is no longer detected from the captured image, the setting unit determines, in accordance with the status in which the specific object is not detected, whether to switch the current main subject to the newly detected main subject candidate.

4. The apparatus according to claim 2, wherein
the status in which the specific object is not detected includes at least one of a position where the specific object disappears from a shooting angle, a direction in which the specific object has moved, movement of the current main subject, and movement of the newly detected main subject candidate.

5. The apparatus according to claim 4, wherein
the position where the specific object disappears from the shooting angle includes a position near a center of the shooting angle or a position not near the center of the shooting angle.

6. The apparatus according to claim 5, wherein
in a case where the position where the specific object disappears from the shooting angle is not near the center of the shooting angle, the setting unit determines, based on the direction in which the specific object has moved and the movement of the newly detected main subject candidate, whether to switch the current main subject to the newly detected main subject candidate.

7. The apparatus according to claim 6, wherein
in a case where the position where the specific object disappears from the shooting angle is not near the center of the shooting angle, in a state in which the specific object has not moved in a predetermined direction, the setting unit determines to switch the current main subject to the newly detected main subject candidate.

8. The apparatus according to claim 6, wherein
in a case where the position where the specific object disappears from the shooting angle is not near the center of the shooting angle, in a state in which the specific object has moved in a predetermined direction and the newly detected main subject candidate has moved by less than a predetermined amount, the setting unit determines not to switch the current main subject to the newly detected main subject candidate.

9. The apparatus according to claim 6, wherein
in a case where the position where the specific object disappears from the shooting angle is not near the center of the shooting angle, in a state in which the specific object has moved in a predetermined direction and the newly detected main subject candidate has moved by not less than a predetermined amount, the setting unit determines to switch the current main subject to the newly detected main subject candidate.

10. The apparatus according to claim 5, wherein
in a case where the position where the specific object disappears from the shooting angle is near the center of the shooting angle, the setting unit determines, based on the movement of the current main subject, whether to switch the current main subject to the newly detected main subject candidate.

11. The apparatus according to claim 10, wherein
in a case where the position where the specific object disappears from the shooting angle is near the center of the shooting angle, in a state in which the current main subject has moved by not less than a predetermined amount and an image capture apparatus has moved toward the current main subject, the setting unit determines not to switch the current main subject to the newly detected main subject candidate.

12. The apparatus according to claim 10, wherein
in a case where the position where the specific object disappears from the shooting angle is near the center of the shooting angle, in a state in which the current main subject has moved by not less than a predetermined amount and an image capture apparatus has not moved toward the current main subject, the setting unit determines to switch the current main subject to the newly detected main subject candidate.

13. The apparatus according to claim 10, wherein
in a case where the position where the specific object disappears from the shooting angle is near the center of the shooting angle, in a state in which the current main subject has moved by less than a predetermined amount, the setting unit determines not to switch the current main subject to the newly detected main subject candidate.

14. The apparatus according to claim 1, wherein
in a case where the main subject candidate is newly detected and the specific object is not detected from the captured image, the setting unit determines to switch the current main subject to the newly detected main subject candidate.

15. The apparatus according to claim 1, further comprising:
a posture obtaining unit that obtains posture information of the subject; and
an action detection unit that detects, based on a detection result of the object detection unit and a detection result of the posture obtaining unit, a subject taking a specific action,
wherein the setting unit sets the main subject based on a detection result of the action detection unit.

16. The apparatus according to claim 15, further comprising:
a calculation unit that calculates, based on at least one of a posture of the subject and a position and a size of the specific object, reliability representing a likelihood of a main subject for each of the plurality of subjects,
wherein the action detection unit detects, as a main subject candidate, a subject with the highest reliability from the plurality of subjects.

17. The apparatus according to claim 16, wherein
the calculation unit calculates the reliability by learning processing, and
in the learning processing, a state of the main subject before shifting to the specific action is learned.

18. The apparatus according to claim 1, further comprising:
a selection unit that selects a type of the sport,
wherein the setting unit executes processing of setting the main subject in accordance with the type of the sport.

19. The apparatus according to claim 1, wherein
the sport is a ball sport, and the specific object is a ball or an object similar to the ball.

20. An image capture apparatus comprising:
an imaging unit;
a subject detection apparatus; and
a focus control unit that executes an autofocus operation for a main subject,
wherein the subject detection apparatus comprises:
a subject detection unit that detects a subject from an image obtained by capturing a sport handling a specific object;
an object detection unit that detects the specific object from the captured image; and
a setting unit that sets a main subject as a target of an autofocus operation from a plurality of subjects detected by the subject detection unit,
wherein even in a case where a main subject candidate is newly detected, in a state in which the specific object is no longer detected from the captured image, the setting unit determines whether to switch a current main subject to the newly detected main subject candidate.

21. A subject detection method comprising:
detecting a subject from an image obtained by capturing a sport handling a specific object;
detecting the specific object from the captured image; and
setting a main subject as a target of an autofocus operation from a plurality of detected subjects,
wherein even in a case where a main subject candidate is newly detected, in a state in which the specific object is no longer detected from the captured image, it is determined in the setting whether to switch a current main subject to the newly detected main subject candidate.

22. A non-transitory computer-readable storage medium storing a program for causing a computer to function as a subject detection apparatus comprising:
a subject detection unit that detects a subject from an image obtained by capturing a sport handling a specific object;
an object detection unit that detects the specific object from the captured image; and
a setting unit that sets a main subject as a target of an autofocus operation from a plurality of subjects detected by the subject detection unit,
wherein even in a case where a main subject candidate is newly detected, in a state in which the specific object is no longer detected from the captured image, the setting unit determines whether to switch a current main subject to the newly detected main subject candidate.
